(19) United States
(12) Patent Application Publication
(10) Pub. No.: US 2025/0206569 A1
(43) Pub. Date: Jun. 26, 2025

(54) UNDERPAN FOR LIFTING SYSTEMS

(71) Applicant: LIFTUP A/S, Støvring (DK)

(72) Inventors: Lars Martiny WIGH, Støvring (DK); Karsten Hvam PEDERSEN, Støvring (DK)

(21) Appl. No.: 18/849,077

(22) PCT Filed: Apr. 19, 2023
(86) PCT No.: PCT/EP2023/060086

§ 371 Date: Sep. 20, 2024

(30) Foreign Application Priority Data
Apr. 20, 2022 (EP) 22169054.8

(51) Int. Cl. B66B 5/02

(52) U.S. Cl. CPC B66B 5/021

(57) ABSTRACT

The invention relates to a lifting system, preferably a platform lift, open or closed, for transporting a person or an object from a first level to a second level, wherein the lifting system comprises an underpan positioned at a bottom surface of a platform, wherein said underpan ensures that no person or objects a present in the area under the platform while the platform is moving up or down, and said underpan is being movably mounted on the bottom surface of the platform by at least one hook-like protrusion, and wherein said hook-like protrusion of the underpan engages with a protruding profile of the platform. Furthermore, the invention relates to a method for stopping the movement of a lifting system. Moreover, the invention relates to a computer program.

### FIELD OF THE INVENTION

The present invention relates to a lifting system for transporting a person or an object from a first level to a second level, wherein the lifting system comprises an underpan being movably mounted on the bottom surface of a platform.

### BACKGROUND OF THE INVENTION

Within the field of lifting systems, especially platform lifting system, it is known that very high security measures must be taken to ensure the transport by lifting systems is secure for both the passengers and for the surroundings.

The invention focuses mainly on the safety of the surroundings of the lifting system, such as the safety of the humans/objects not being transported by the lift.

To secure that no person, animal or any other object risks to be crushed or otherwise damaged while the lifting system is moving up and especially down, it is known in the field of lifting systems to somehow attempt to detect if any person, animal or object is located or positioned under the lift.

However, the detection systems and methods used today are often not trustworthy enough relative to the danger and damage a lifting system in movement can impose. In addition, the detection systems and methods are often extremely complex, very expensive, and very difficult to maintain and service.

Hence, an improved lifting system and method for stopping the movement of a lifting system would be advantageous, and in particular, a more efficient, reliable and/or safe lifting system and method would be advantageous.

### OBJECT OF THE INVENTION

In particular, it may be seen as an object of the present invention to provide a lifting system and method for stopping the movement of a lifting system that solves the above mentioned problems of the prior art.

It is a further object of the present invention to provide an alternative to the prior art.

### SUMMARY OF THE INVENTION

Thus, the above described object and several other objects are intended to be obtained in a first aspect of the invention by providing a lifting system for transporting a person or an object from a first level to a second level, wherein the lifting system comprises:
a drive unit, said drive unit preferably comprising at least a motor, preferably an electric motor,
a platform, said platform being an open platform or a closed platform, and said platform comprising a protruding profile,
a main structure, wherein said main structure is adapted to facilitate an up and/or down movement of the platform,
a drive system positioned on or within the main structure, wherein said drive system is adapted to facilitate the up and down movement of the platform,
an underpan positioned at a bottom surface of the platform,
   wherein the underpan comprises at least one hook-like protrusion, preferably elongated, and
   wherein the underpan is movably mounted on the bottom surface of the platform by the at least one hook-like protrusion, and wherein said hook-like protrusion of the underpan engages with the protruding profile of the platform.

The invention is particularly, but not exclusively, advantageous for obtaining a lifting system providing an absolute safe and secure lift configuration. The arrangement of the underpan ensures that no living creature (such as human or animal) or object is present in the area under the platform while the platform is moving up or down, and thereby securing that no person, animal or object can be injured under the lifting system, when the lifting system is moving.

Furthermore, the movable mounting of the underpan on the platform makes the installation of the underpan easier, quicker and more efficient. The installation and mounting of the underpan on the bottom surface of the platform can be performed by only one person.

Moreover, the underpan arrangement makes the service and maintenance of the lifting system and particularly the underpan much easier.

Also, since the underpan is movably attached to the bottom of the platform, there is no need of regular adjustments or service of the underpan. The underpan will adjust itself and ensure its correct and optimal position.

Within the context of the invention it should be understood, that when referring to “a first level” and/or “a second level”, it is to be understood as two different floors, which can be any floor in the building, and is not necessarily to be understood as the first floor and the second floor of the building.

### Some Examples for the Understanding:

The platform moving up:
   “First level”=first floor & “second level”=second floor,
   “First level”=first floor & “second level”=fourth floor, or
   “First level”=basement & “second level”=first floor,
   And so on.
The platform moving down:
   “First level”=third floor & “second level”=second floor, or
   “First level”=fifth floor & “second level”=first floor, or
   “First level”=fourth floor & “second level”=basement,
   And so on.

Within the context of the invention a “closed platform” may be understood as e.g. a cabin, or the like.

Within the context of the invention a “drive system” can be any system adapted to facilitate the up and down movement of the platform. The drive system may be a belt drive, chain drive, rope or the like.

Within the context of the invention an “underpan” may be understood as one or more plates positioned at the bottom surface of the platform/under a lifting system, wherein the plate is adapted for acting as a safety stop, stopping the movement of the platform of the lifting system, if needed.

In an embodiment of the invention, the at least one hook-like protrusion is elongated.

The embodiment is particularly, but not exclusively, advantageous for obtaining a mounting of the underpan to the platform being reliable, strong and durable

Within the context of the invention an “elongated hook-like protrusion” may be understood as the protrusion of the underpan runs along the majority of or the entire length of the side(s) of the underpan (or underpan plates).

However, it should be understood that the elongated hook-like protrusion is a preferred embodiment.

The hook-like protrusion of the underpan (or underpan plates) may be a protrusion with a smaller extent, thereby not elongated, it may be only one small extent protrusion or a plurality of smaller protrusion, depending on the configuration of the underpan and the lifting system.

In an embodiment of the invention, the main structure comprises at least a column, a frame or a rail, preferably two columns.

The embodiment is particularly, but not exclusively, advantageous for obtaining a lifting system, wherein the platform of the system can move up and down in a smooth and reliable way.

Furthermore, the main structure being at least a column, a frame or a rail makes the mounting of the lifting system on an associated building possible, reliable and simple.

In an embodiment of the invention, at least one sensor is positioned at the bottom surface of the platform adapted for sensing any movement of the underpan, preferably a plurality of sensors is positioned at the bottom surface of the platform, and preferably the at least one sensor is a light beam sensor or an optical sensor.

The embodiment is particularly, but not exclusively, advantageous for obtaining a lifting system, wherein the detection of any obstacle under a moving platform, such as a person, an animal or an object, is detected by a reliable and fast technique. Using a sensor according to the above embodiment ensures that whenever the underpan is moving in an upward direction, the sensor will detect even the smallest movement and guarantees that the lift/platform stops moving immediately.

Preferably, the stop of the movement is achieved by switching off the safety circuit of the platform lift.

In an embodiment of the invention, the at least one sensor is located above an engagement point of the hook-protrusion of the underpan and the protruding profile of the platform, and said sensor being adapted to stop the lift from moving if activated.

The embodiment is particularly, but not exclusively, advantageous for obtaining a lifting system, wherein the sensor is located in a position ensuring, that it is never blocked or damaged, and such that it ensures detection of any minor movement in an upward direction of the underpan.

In an embodiment of the invention, at least one switch, preferably an electromechanical switch, is positioned at the bottom surface of the platform adapted for switching off the safety circuit of the platform lift, stopping the movement of the platform, preferably a plurality of switches is positioned at the bottom surface of the platform.

The embodiment is particularly, but not exclusively, advantageous for obtaining a lifting system, wherein the detection of any obstacle under a moving platform, such as a person, an animal or an object, is detected by a reliable and fast technique. Using a switch according to the above embodiment ensures that whenever the underpan is moving in an upward direction, the switch will be affected by even the smallest movement of the underpan and guarantees that the lift stops moving immediately, achieved by switching off the safety circuit of the platform lift.

In an embodiment of the invention, the underpan comprises a plurality of plates being assembled into one underpan, preferably four plates are assembled.

The embodiment is particularly, but not exclusively, advantageous for obtaining an underpan arrangement being more simple and cheaper to produce, being easier to transport and handle, and especially being easier to install and mount on the lifting system, preferably on the bottom surface of the platform.

In an embodiment of the invention, the underpan comprises an end piece.

The embodiment is particularly, but not exclusively, advantageous for obtaining an end configuration of the underpan ensuring that the underpan consisting of one or more pieces are preserved in a correct position, meaning that the underpan can only move in a sideway direction within a predetermined limit. In some configurations of the underpan, it may be that the underpan cannot move in a sideway direction due to the end piece.

In an embodiment of the invention, the underpan is mounted at the bottom surface of the platform by sliding the one or more underpan plates from the side or end below the platform, wherein the hook-like protrusion of the underpan and the protruding profile of the platform are movably engaging.

The embodiment is particularly, but not exclusively, advantageous for obtaining an easy and reliable installation and mounting of the underpan. The installation can be performed by only one person alone. Further, the installation needs no adjustment, since the underpan adjust itself.

In an embodiment of the invention, the lifting system further comprises at least one elongated element, preferably two or more elongated elements, positioned at the bottom surface of the platform and extending at least substantially from a first end to a second end of the platform.

The embodiment is particularly, but not exclusively, advantageous for obtaining a lifting system, wherein an elongated element of the underpan can distribute any force detected on the underpan, such as when the underpan is moving in an upward direction. If the underpan comprises a plurality of plates, the force/movement exposed to one plate will be distributed along the elongated element. The distribution of force allows the lifting system to comprise a lot fewer sensors and/or switches and still provides the same level of safety.

Within the context of the invention an “elongated element” may be understood as a force distribution profile or a pressure plate, or the like.

In an embodiment of the invention, the elongated element is adapted to transfer pressure force applied to one or more of the underpan plates.

The embodiment is particularly, but not exclusively, advantageous for obtaining a lifting system comprising a lot fewer sensors and/or switches and still provides the same level of safety.

In an embodiment of the invention, the at least one elongated element engages with at least two underpan plates.

The embodiment is particularly, but not exclusively, advantageous for obtaining a lifting system comprising a lot fewer sensors and/or switches and still provides the same level of safety.

In an embodiment of the invention, the lifting system comprises a plurality of assembled underpan plates, and wherein the at least one elongated element engages with any of the plurality of underpan plates, preferably the elongated element is positioned transverse a longitudinal direction of the underpan plate assemblies.

The embodiment is particularly, but not exclusively, advantageous for obtaining a lifting system comprising a lot fewer sensors and/or switches and still provides the same level of safety.

In an embodiment of the invention, the lifting system is a platform lift system, comprising at least one column, preferably two columns, wherein a platform is adapted to move up and down on the at least one column via the drive system.

The embodiment is particularly, but not exclusively, advantageous for obtaining a safe and secure platform lifting system.

In an embodiment of the invention, the lifting system is an elevator, comprising at least one rail or frame, wherein a platform in form of an elevator car is adapted to move up and down on the at least one rail or frame.

The embodiment is particularly, but not exclusively, advantageous for obtaining a safe and secure elevator lifting system.

The invention further relates to a second aspect being a method for stopping the movement of a lifting system, preferably a lifting system according to any of the preceding claims, wherein the method comprises the steps of:
moving a platform in a downwards direction,
having at least one underpan affected by a pressure force, such that the underpan is moving in an upward direction by said pressure force,
sensing the movement of the underpan by at least one sensor or by activating at least one switch,
stopping the movement of the platform, preferably by switching off the safety circuit,
optionally, clearing the area from any obstacles beneath the platform lift,
starting the movement of the platform, preferably by switching on the safety circuit, and
   wherein the steps can be performed in any order, subsequently and/or simultaneously.

This aspect of the invention is particularly, but not exclusively, advantageous for obtaining a method for stopping the movement of a lifting system providing an absolute safe and secure method ensuring that no person or object is present in the area under the platform while the platform is moving up or down, and thereby securing that no person, animal or object can be injured under the lifting system, when the lifting system is moving.

In an embodiment of the invention, the method further comprises the step of:
transferring the pressure force applied to at least one underpan via an elongated element, such that the force applied is transferred to activate at least one sensor or at least one switch.

The embodiment is particularly, but not exclusively, advantageous for obtaining a method, wherein the underpan can distribute any force exposed to the underpan, such as when the underpan is moving in an upward direction. If the underpan comprises a plurality of plates, the force/movement detected of one plate can be distributed along the elongated element. The distribution of force allows the lifting system to comprise a lot fewer sensors and/or switches and still provides the same level of safety.

The invention further relates to a third aspect being a computer program comprising instructions which, when the program is executed by a computer, cause the computer to carry out the method of at least claim 15.

The first, second and third aspect of the present invention may each be combined with any of the other aspects. These and other aspects of the invention will be apparent from and elucidated with reference to the embodiments described hereinafter.

### BRIEF DESCRIPTION OF THE FIGURES

The lifting system according to the invention will now be described in more detail with regard to the accompanying figures. The figures show one way of implementing the present invention and are not to be construed as being limiting to other possible embodiments falling within the scope of the attached claim set.

FIG. 1a illustrates in 3D view a lifting system from below.

FIG. 1b illustrates in 3D view a lifting system from a front/side view.

FIG. 2a illustrates a lifting system from a side view.

FIG. 2b illustrates a lifting system from a front view.

FIG. 2c illustrates a lifting system from an upper view.

FIG. 3 illustrates underpan plates with elongated elements and switches.

FIG. 4a illustrates a side view of a platform.

FIG. 4b illustrates a side view cross section of a platform.

FIG. 5a illustrates a front view cross section of a platform.

FIG. 5b illustrates a front view cross section of a corner of a platform.

FIG. 6 illustrates in 3D a cross section a platform.

FIGS. 7a and 7b illustrate in 3D an underpan plate.

FIG. 7c illustrates in 3D an underpan end plate.

FIGS. 8a, 8b, 8c and 8d illustrate perspectives of an elongated element.

FIG. 9 illustrates a mounting/installation method of underpan plates and an end plate.

FIG. 10 illustrates a cross section of a protruding profile and a hook-protrusion and a sensor.

### DETAILED DESCRIPTION OF AN EMBODIMENT

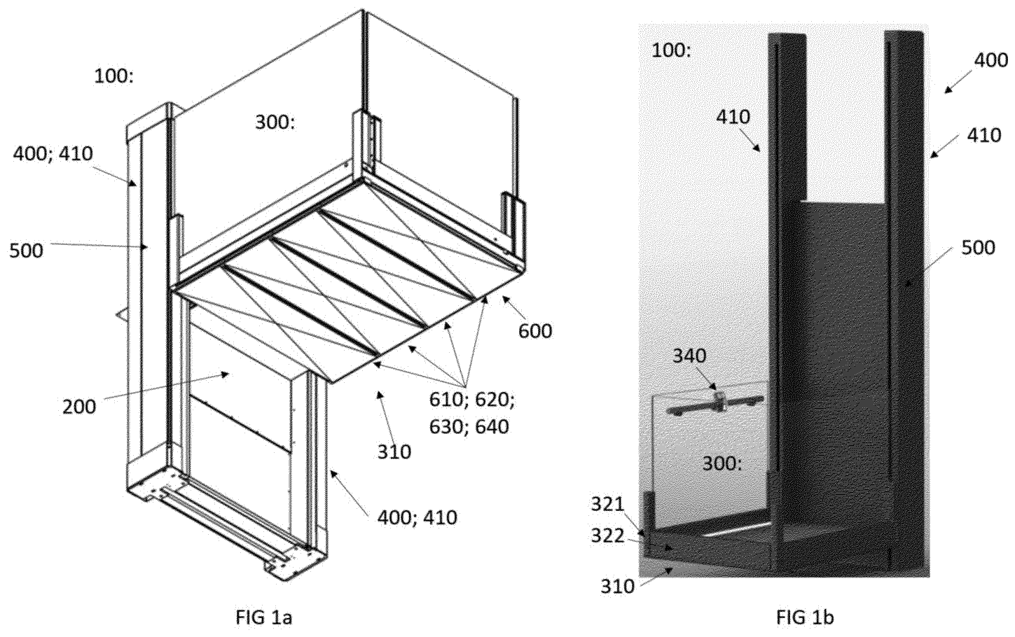

FIGS. 1a and 1b illustrate in a 3D view a lifting system 100 for transporting a person or an object from a first level to a second level.

FIG. 1a illustrates the lifting system from below and FIG. 1b illustrates the lifting system 100 from a front/side-view.

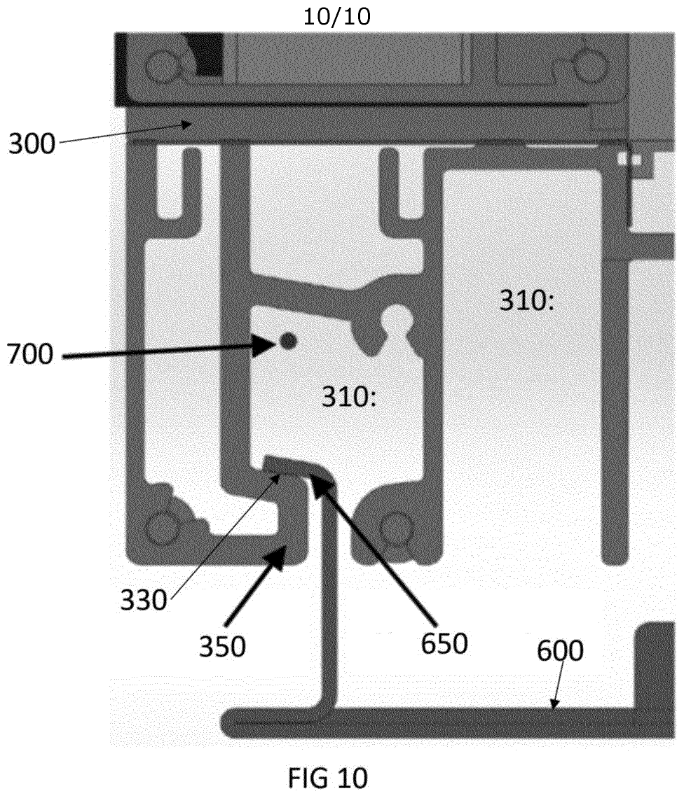

The lifting system illustrated in FIGS. 1a and 1b comprises:
A drive unit 200, said drive unit preferably comprising at least a motor, preferably an electric motor (not shown). The drive unit 200 can take many different positions, and the position illustrated in FIG. 1a is only an example, the position of the drive unit should therefore not have a limiting effect for the invention.
A platform 300, said platform being an open platform, however within the invention the platform can also be a closed platform, said platform comprising a protruding profile (not illustrated in FIG. 1, see FIG. 10)
A main structure 400, wherein said main structure is adapted to facilitate an up and/or down movement of the platform 300, the main structure 400 in FIGS. 1a and 1b is illustrated as being two columns 410, however the main structure can within the invention be least a column, a frame or a rail.
A drive system 500 positioned on or within the main structure 400 (not illustrated in FIG. 1), wherein said drive system 500 is adapted to facilitate the up and down movement of the platform 300, said drive system is preferably a belt drive, however other drive systems can be used within the invention.
An underpan 600 positioned at a bottom surface 310 of the platform, the underpan 600 illustrated in FIG. 1a comprises four underpan plates 610, 620, 630, 640.

Furthermore, the underpan 600 of the invention comprises at least one hook-like protrusion 650 (not illustrated in FIG. 1—See FIG. 10), and the underpan is movably mounted on the bottom surface 310 of the platform by the at least one elongated hook-like protrusion 650, and wherein said hook-like protrusion of the underpan 600 engages with the protruding profile 350 of the platform 300 (not illustrated in FIG. 1—See FIG. 10).

The lifting system 100 illustrated in FIGS. 1a and 1b is a platform lift system 110, comprising at least one column 410, preferably two columns, wherein the platform 300 is adapted to move up and down on the at least one column 410 via a drive system 500, preferably a belt drive. However, the lifting system can also be such as an elevator lifting system 120.

The materials of the lifting system 100 is in FIG. 1b illustrated as a combination of metal and glass. The main structure 400 being manufactured in metal, and the platform being manufactured in partly metal and having the sides made in glass plates. However, these materials are only preferred materials and should not be seen as limiting for the invention.

Moreover, the lifting system 100 illustrated in FIGS. 1a and 1b is configured for performing a method of stopping the movement of a platform 300 of a lifting system 100, wherein the method comprises the steps of:
moving a platform 300 in a downwards direction,
having at least one underpan 600 affected by a pressure force, such that the underpan is moving in an upward direction by said pressure force,
sensing the movement of the underpan 600 by at least one sensor 700 or by activating at least one switch 800,
stopping the movement of the platform 300, preferably by switching off the safety circuit,
optionally, clearing the area from any obstacles beneath the platform lift,
starting the movement of the platform 300, preferably by switching on the safety circuit,
   wherein the steps can be performed in any order, subsequently and/or simultaneously.

Also, the lifting system 100 illustrated in FIGS. 1a and 1b is suitable for being connected to a computer program comprising instructions which, when the program is executed by a computer, cause the computer to carry out the above method.

It should be understood, that within the context of the invention, the lifting system 100 of the invention comprising an underpan 600 could be manufactured in many different configurations. The lifting system and the platform illustrated in FIG. 1 is an open platform lift, however the lifting system and the platform can also be manufactured as an elevator 120, comprising at least one rail or frame, wherein a platform in form of an elevator car is adapted to move up and down on the at least one rail or frame.

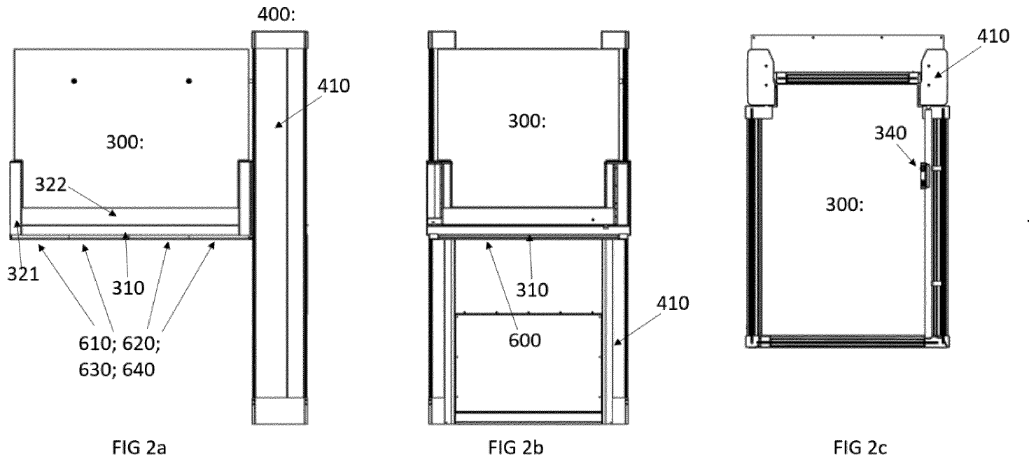

FIGS. 2a and 2b illustrates a lifting system 100 from a side view and a front view. The figure should only be seen as an illustration. The platform illustrated in FIGS. 2a and 2b is illustrated with a height/elevation being very limited, however the potential height/elevation of the lifting system within the invention should be understood to be several meters and potentially cover a pluralities of floors, such as up to 10-15 meter, even up to 20 meters or more.

FIG. 2c illustrates a lifting system 100 from an upper view. The lifting system illustrated has a platform 300 shape as a rectangular, being the preferred shape. However, the platform 300 can take many shapes within the invention, such as curved, and the rectangular shape should therefore not be understood as limiting.

The lifting system illustrated in FIGS. 2a, 2b and 2c further comprises platform side-supports 320, for supporting the sides of the platform 300. The lifting system 100 illustrated comprises both vertical platform side-supports 321 and horizontal platform side-supports 322. However, the platform may potentially comprise only the vertical or only the horizontal platform side-supports 320, or none of them.

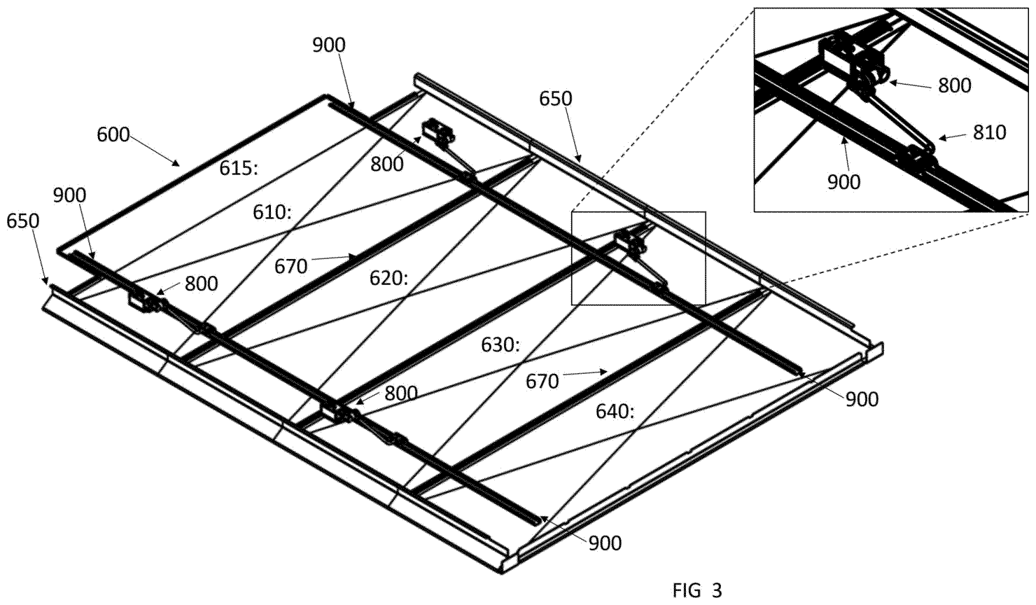

FIG. 3 illustrates underpan plates 610, 620, 630, 640 with elongated elements 900 and switches 800. The number of underpan plates in FIG. 3 is four, which is the preferred number. However, the number of plates 610, 620, 630, 640 should not be seen as limiting for the invention. The number of plates can be one plate, preferably 2-8 plates, more preferably 3-4 plates. However, the number of plates 610, 620, 630, 640 may be even more than eight plates, depending on the size and shape of the platform 300.

Moreover, FIG. 3 illustrates a lifting system 100 comprising at least one elongated element 900, preferably two as illustrated, or more, elongated elements. The elongated elements 900 are positioned at the bottom surface 310 of the platform 300 thereby engaging with a surface of the underpan 600 as illustrated, and extending at least substantially from a first end to a second end of the underpan 600/underpan plates 610, 620, 630, 640.

As illustrated, it is preferred that the one or more elongated element 900 engages with at least two underpan plates 610. The most preferred configuration is that the one or more elongated elements 900 engage with all the underpan plates 610 of the lifting system 100.

If four underpan plates, as illustrated in FIG. 3, it is thereby preferred that the elongated element is engaging with all the four underpan plates 610, 620, 630, 640, since the elongated element is adapted to transfer pressure force applied to one or more of the underpan plates.

In FIG. 3, the at least one elongated element 900 engages with any of the plurality of underpan plates 610, 620, 630, 640 and the elongated element is positioned transverse a longitudinal direction of the underpan plate assemblies 670, which is the preferred configuration. However, the elongated element 900 can be positioned in other configurations, such as obliquely across the plates 610.

Furthermore, FIG. 3 illustrates a lifting system 100 comprising at least one switch 800, preferably an electromechanical switch. In FIG. 3, four switches 800 are shown, however the number of switches may vary depending on the size and shape of the platform 300. The at least one switch 800 is positioned at the bottom surface 310 of the platform, thereby engaging with the underpan 600. The switches 800 are adapted for switching off the safety circuit of the lifting system 100 and thereby stopping the movement of the platform 300, if needed.

The elongated element 900 illustrated in FIG. 3 is overall adapted for transferring the pressure force applied to at least one underpan 600 via the elongated element 900, such that the force applied is transferred to activate at least one switch 800 or alternatively at least one sensor 700 (not shown—See FIG. 10).

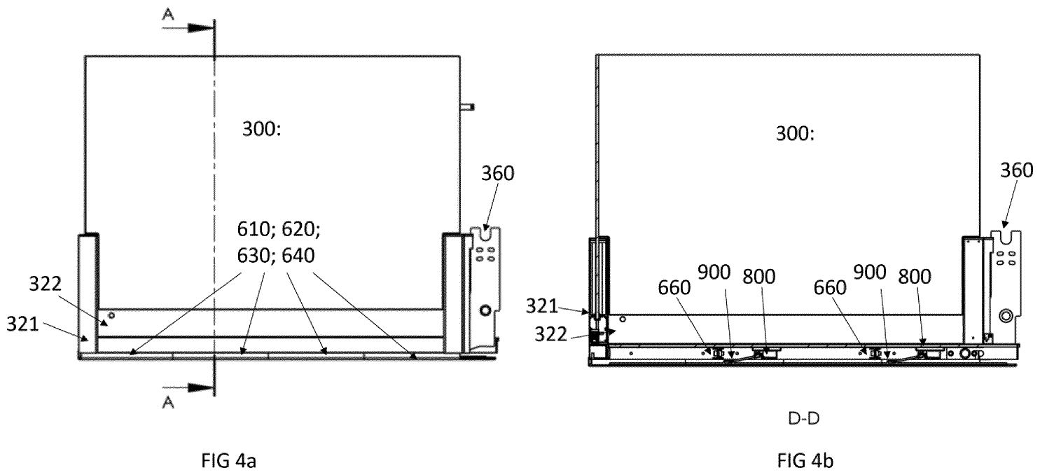

FIGS. 4a and 4b illustrate a side view of a platform 300, wherein FIG. 4b illustrates a side view cross section of a platform 300. From the cross section, a potential position of the switches 800 is illustrated. Two switches 800 are shown in the cross section, being the preferred number of switches 800 positioned at each side of the platform 300, meaning four switches 800 in total.

Moreover, the lifting system illustrated in FIGS. 4a and 4b comprises platform side-supports 320, for supporting the sides of the platform. The lifting system 100 illustrated comprises both vertical platform side-supports 321 and horizontal platform side-supports 322. Also, an platform mounting element 360 is illustrated, the platform mounting element is used to mount the platform inside the column 410 (not illustrated). The platform mounting element is screwed on to the drive system and it is thus holding the platform. Preferably, two platform mounting elements are provided, one for mounting inside each of the preferred two columns 410. This way of mounting the platform to the main structure/columns should not be seen as limiting to the invention, it is only one of many mounting methods possible within the lifting system of the invention.

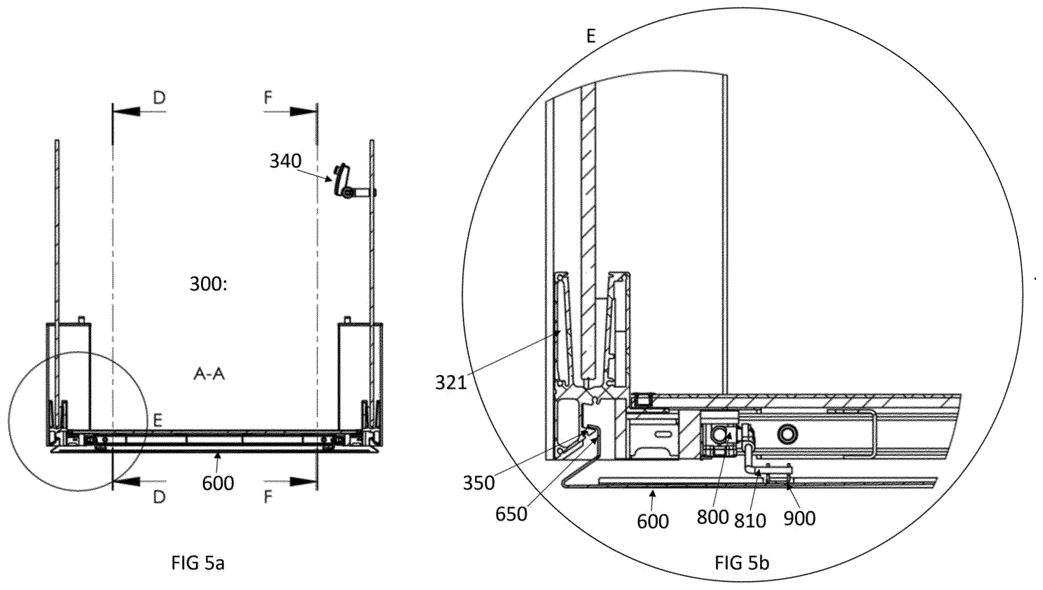

FIG. 5a illustrates a front view cross section of a platform 300 and FIG. 5b illustrates a front view cross section of a corner of a platform 300. It is illustrated that the lower part of the switch 800 is engaging or connected to an elongated element 900, such that if the elongated element 900 is exposed to a force, the force applied will be transferred to activate the at least at least one switch 800.

The switches 800 illustrated in FIG. 5b comprise a bent rod 810, however the shape and design of the switches 800 should not be seen as limiting to the invention.

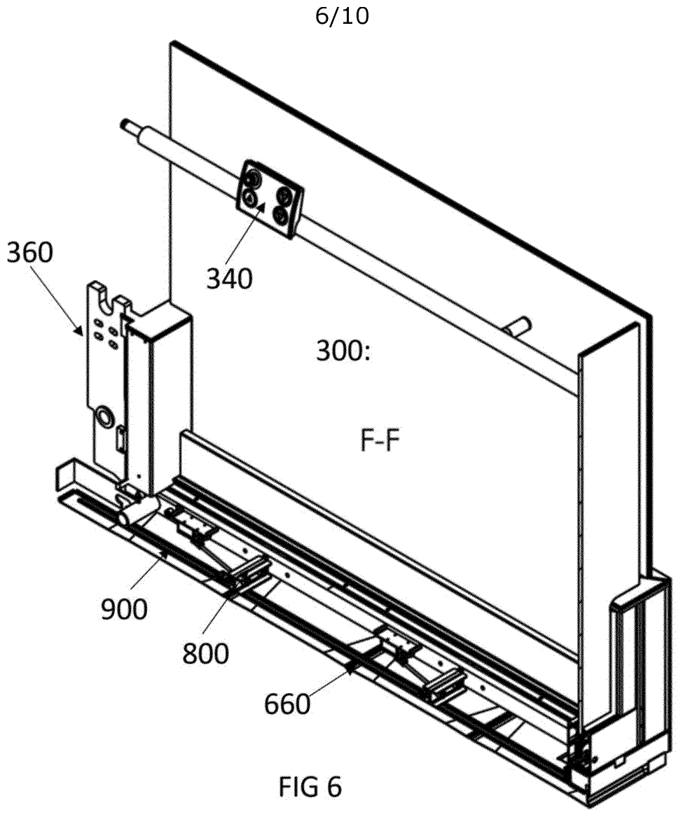

FIG. 6 illustrates in 3D a cross section a platform. From the cross section, a potential position of the switches 800 is illustrated. Two switches 800 are shown in the cross section, being the preferred number of switches 800 positioned at each side of the platform, meaning four switches 800 in total (not illustrated in the FIG. 6—see FIG. 3).

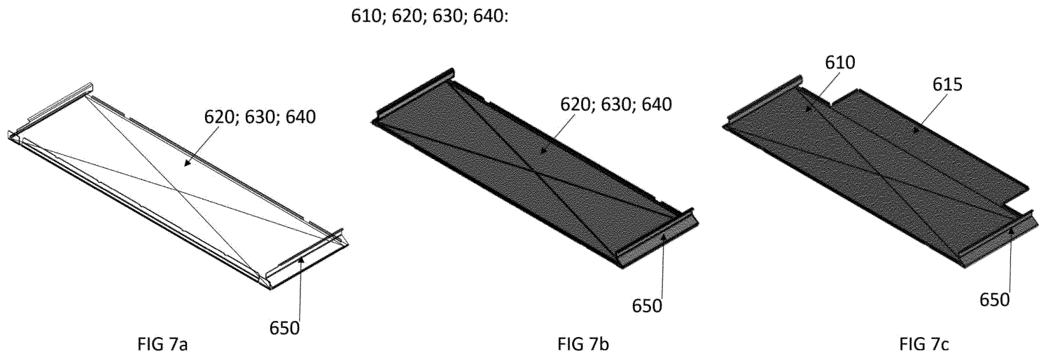

FIGS. 7a and 7b illustrate in 3D an underpan 600. The underpan 600 comprises at least one elongated hook-like protrusion 650, and the underpan is adapted to be movably mounted on the bottom surface 310 of the platform 300 by the at least one elongated hook-like protrusion 650. Said hook-like protrusion of the underpan is adapted to engage with a protruding profile of the platform 350 (not illustrated in FIG. 7—See FIG. 10). The hook-like protrusion can also take other shapes than elongated within the invention.

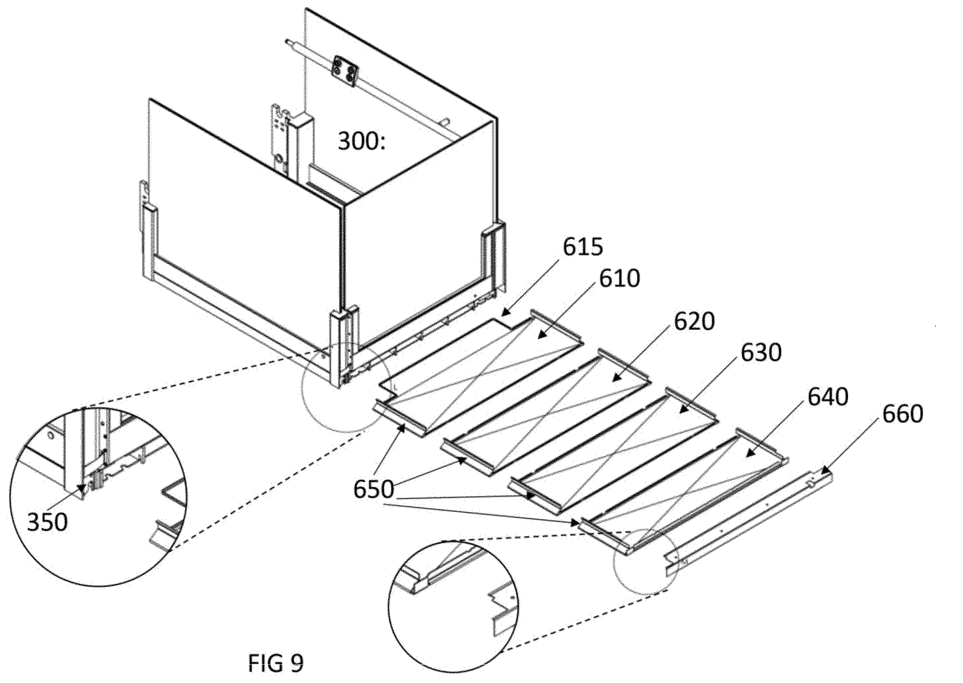

FIG. 7c illustrates in 3D an underpan plate. The underpan plate having an extended part 615. The extended part 615 is suitable for and intended to fit between the columns. Therefore, the underpan plate having an extended part 615 will be the first one to be inserted, as illustrated in FIG. 9.

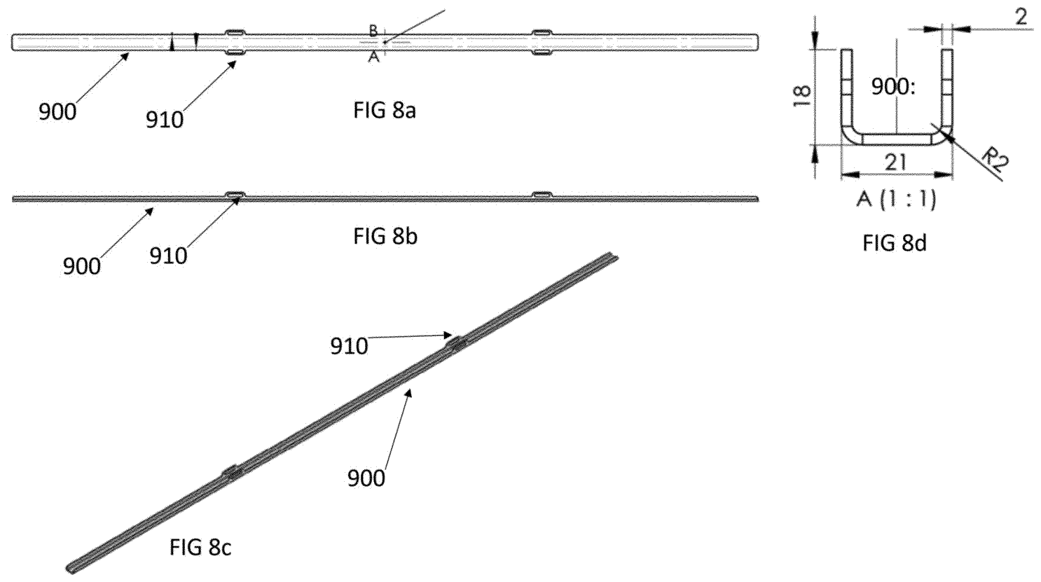

FIGS. 8a, 8b, 8c and 8d illustrate perspectives of an elongated element 900. The design of the elongated elements can take many different shapes, however the illustrated elongated element in FIG. 8 is the preferred embodiment.

The elongated element 900 illustrated takes a U-shape, when seen in a cross-section from the front/back of the element (See FIG. 8d).

The length of the elongated element 900 will vary depending on the length of the underpan configuration.

The width of the elongated element 900 will vary depending on the configuration of the lifting system. In FIG. 8d, an example of the width is 21 mm, however this is only an example, and the width of the elongated element can take any suitable dimension depending on the rest of the lifting system.

The height of the elongated element 900 will vary depending on the configuration of the lifting system 100. In FIG. 8d, an example of the height is 18 mm, however this is only an example, and the height of the elongated element can take any suitable dimension depending on the rest of the lifting system.

The thickness of the elongated element 900 will vary depending on the platform configuration. In FIG. 8d, an example of the thickness is 2 mm, however this is only an example, and the thickness of the elongated element can take any suitable dimension depending on the rest of the lifting system.

Moreover, the elongated elements 900 illustrated in FIG. 8a-c comprise two sets of protruding parts including a hollow section 910. These protruding parts are adapted to engage with the switches 800, such that a part of the switches is inserted into the hollow sections 910 (Not illustrated in FIG. 8—See FIG. 3). However, this engaging method should only be seen as one alternative of many. The elongated elements 900 can within the invention engage with the switches 800 or sensors 700 in any other suitable way

The lifting system 100 of the invention comprises at least one elongated element 900, preferably two or more elongated elements, positioned at the bottom surface 310 of the platform 300 and extending at least substantially from a first end to a second end of the platform.

The elongated element is adapted to transfer pressure force applied to one or more of the underpan plates 610.

FIG. 9 illustrates a mounting/installation method of underpan plates 610, 620, 630, 640 and an end-plate 660. The underpan 600 illustrated in FIG. 9 comprises a plurality of plates 610, 620, 630, 640 being assembled into one underpan 600, preferably four plates are assembled as illustrated.

Furthermore, the underpan 600 comprises an end plate 660, said end piece ensures the desired position of the underpan (plates) is kept in place.

The underpan 600 is mounted at the bottom surface 310 of the platform, preferably by sliding the one or more underpan plates from the side or end below the platform. In FIG. 9, the plates 610, 620, 630, 640 are mounted from the front end. During the mounting and after mounting, the elongated hook-like protrusion 650 of the underpan 600 and the protruding profile 350 of the platform 300 are movably engaging.

FIG. 10 illustrates a cross section of a protruding profile 350 and a hook-protrusion 650 and a sensor 700. The underpan 600 comprises at least one hook-like protrusion 650, and the underpan is movably mounted on the bottom surface 310 of the platform 300 by the at least one hook-like protrusion 650, and wherein said hook-like protrusion of the underpan engages with the protruding profile 350 of the platform 300.

Furthermore, FIG. 10 illustrates a lifting system 100 with an underpan 600, wherein a sensor 700 is positioned at the bottom surface 310 of the platform 300 adapted for sensing any movement of the underpan 600, preferably a plurality of sensors 700 is positioned at the bottom surface of the platform, and preferably the at least one sensor is a light beam sensor or an optical sensor.

The at least one sensor 700 is located above an engagement point 330 of the hook-protrusion 650 of the underpan 600 and the protruding profile 350 of the platform 300, and said sensor 700 being adapted to stop the platform 300 from moving if activated.

The lifting system 100 of the invention may comprise both sensors 700 and switches 800 (not illustrated), however the preferred embodiment is either that said system comprises switches or comprises sensors.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims may possibly be advantageously combined, and the mentioning of these features in different claims does not exclude that a combination of features is not possible and advantageous.

### REFERENCE LIST

A lifting system (100)
Drive unit (200)
Platform (300)
Bottom surface of platform (310)
Platform side-supports (320)
Vertical platform side-supports (321)
Horizontal platform side-supports (322)
Engagement point (330)
Control panel (340)
Protruding profile (350)
Platform mounting element (360)
Bottom surface of the platform (310)
Main structure (400)
Column (410)
Drive system (500)
Underpan (600)
Underpan plates (610, 620, 630, 640)
Hook-like protrusion of the platform (650)
End plate (660)
Assemblies of underpan plates (670)
Sensor (700)
Switch (800)
Bent rod (810)
Elongated element (900)
Hollow section (910)

1. A lifting system for transporting a person or an object from a first level to a second level, wherein the lifting system comprises:
a drive unit, said drive unit preferably comprising at least a motor, preferably an electric motor,
a platform, said platform being an open platform or a closed platform, and said platform comprising a protruding profile,
a main structure, wherein said main structure is adapted to facilitate an up and/or down movement of the platform,
a drive system positioned on or within the main structure, wherein said drive system is adapted to facilitate the up and down movement of the platform,
an underpan positioned at a bottom surface of the platform,
wherein the underpan comprises at least one hook-like protrusion, preferably elongated, and
wherein the underpan is movably mounted on the bottom surface of the platform by the at least one hook-like protrusion, and wherein said hook-like protrusion of the underpan engages with the protruding profile of the platform.

2. The lifting system according to claim 1, wherein the main structure comprises at least a column, a frame or a rail, preferably two columns.

3. The lifting system according to claim 1, wherein at least one sensor is positioned at the bottom surface of the platform adapted for sensing any movement of the underpan, preferably a plurality of sensors is positioned at the bottom surface of the platform, and preferably the at least one sensor is a light beam sensor or an optical sensor.

4. The lifting system according to claim 3, wherein the at least one sensor is located above an engagement point of the hook-protrusion of the underpan and the protruding profile of the platform, and said sensor being adapted to stop the platform from moving if activated.

5. The lifting system according to claim 1, wherein at least one switch, preferably an electromechanical switch, is positioned at the bottom surface of the platform adapted for switching off a safety circuit of the lifting system, stopping the movement of the platform, preferably a plurality of switches is positioned at the bottom surface of the platform.

6. The lifting system according to claim 1, wherein the underpan comprises a plurality of underpan plates being assembled into one underpan, preferably four plates are assembled.

7. The lifting system according to claim 1, wherein the underpan comprises an end plate.

8. The lifting system according to claim 1, wherein the underpan is mounted at the bottom surface of the platform by sliding the one or more underpan plates from the side or end below the platform, wherein the hook-like protrusion of the underpan and the protruding profile of the platform are movably engaging.

9. The lifting system according to claim 1, wherein the lifting system further comprises at least one elongated element, preferably two or more elongated elements, positioned at the bottom surface of the platform and extending at least substantially from a first end to a second end of the platform.

10. The lifting system according to claim 9, wherein the elongated element is adapted to transfer pressure force applied to one or more of the underpan plates.

11. The lifting system according to claim 9, wherein the at least one elongated element engages with at least two underpan plates.

12. The lifting system according to claim 1, wherein the lifting system comprises a plurality of assembled underpan plates, and wherein the at least one elongated element engages with any of the plurality of underpan plates, preferably the elongated element is positioned transverse a longitudinal direction of the underpan plate assemblies.

13. The lifting system according to claim 1, wherein the lifting system is a platform lift system, comprising at least one column, preferably two columns, wherein a platform is adapted to move up and down on the at least one column via the drive system.

14. A method for stopping the movement of a platform of a lifting system, preferably a lifting system according to claim 1, wherein the method comprises the steps of:
moving a platform in a downwards direction,
having at least one underpan affected by a pressure force, such that the underpan is moving in an upward direction by said pressure force,
sensing the movement of the underpan by at least one sensor or by activating at least one switch,
stopping the movement of the platform, preferably by switching off the safety circuit,
optionally, clearing the area from any obstacles beneath the platform,
starting the movement of the platform, preferably by switching on the safety circuit, and
wherein the steps can be performed in any order, subsequently and/or simultaneously.

15. The method according to claim 14, wherein the method further comprises the step of:
transferring the pressure force applied to at least one underpan via an elongated element, such that the force applied is transferred to activate at least one sensor or at least one switch.

16. A computer program comprising instructions which, when the program is executed by a computer, cause the computer to carry out the method of at least claim 14.
